(19) United States
(12) Patent Application Publication
(10) Pub. No.: US 2020/0096386 A1
(43) Pub. Date: Mar. 26, 2020

(54) METHOD, CONTROL UNIT AND SYSTEM FOR DETECTING AN OSCILLATION OF A VEHICLE PART FOR A VEHICLE

(71) Applicant: ZF Friedrichshafen AG, Friedrichshafen (DE)

(72) Inventor: Ajoy PALIT, Bremen (DE)

(73) Assignee: ZF Friedrichshafen AG, Friedrichshafen (DE)

(21) Appl. No.: 16/496,318

(22) PCT Filed: Feb. 19, 2018
(86) PCT No.: PCT/EP2018/053971

§ 371 Date: Sep. 20, 2019

(30) Foreign Application Priority Data
Mar. 24, 2017 (DE) 10 2017 205 052.7

(51) Int. Cl. G01H 11/02; G01M 17/007

(52) U.S. Cl. CPC G01H 11/02; G01M 17/007

(57) ABSTRACT

A method for detecting an oscillation of a vehicle part for a vehicle contains a step for applying an electric excitation signal to at least one electric coil. The at least one electric coil is inductively coupled to at least one position element. The at least one position element is coupled to the vehicle part. The method also contains a step for inputting an electric coil signal from the at least one electric coil. The electric coil signal is tapped at the at least one coil in response to the electric excitation signal and affected by the at least one position element. The method also contains a step for determining at least one property of the oscillation of the vehicle part based on the input electric coil signal.

### RELATED APPLICATIONS

This application is a filing under 35 U.S.C. § 371 of International Patent Application PCT/EP2018/053971, filed Feb. 19, 2018, claiming priority to German Patent Application 10 2017 205 052.7, filed Mar. 24, 2017. All applications listed in this paragraph are hereby incorporated by reference in their entireties.

### TECHNICAL FIELD

The present invention relates to a method for detecting an oscillation of a vehicle part for a vehicle, a corresponding control unit, a system for detecting an oscillation of a vehicle part for a vehicle, a vehicle that has such a system, and a use of a detection device for detecting an oscillation of a vehicle part for a vehicle.

### BACKGROUND

A detection or measurement of oscillations is obtained by a typical method for checking and also monitoring materials and components. Different measurement principles may be used in the industry for this.

### SUMMARY

Based on this, the present invention creates an improved method for detecting an oscillation of a vehicle part for a vehicle, an improved control unit, an improved system for detecting an oscillation of a vehicle part for a vehicle, an improved vehicle, and an improved use of a detection device for detecting an oscillation of a vehicle part for a vehicle in accordance with the independent claims. Advantageous embodiments can be derived from the dependent claims and the following description.

According to embodiments of the present invention, an inductive oscillation detection can be used in particular for measuring oscillations, e.g. in the field of automobile electronics, passengers cars, vehicles, etc. In particular, the inductive oscillation detection can be implemented using at least one planar coil. By way of example, an inductive oscillation sensor containing at least one electrical coil can be configured to detect an oscillation of at least one vehicle part for a vehicle.

Advantageously, physical variables, in particular oscillations, noises, sounds, pressure, forces, compression pressures, etc. in a vehicle, can be reliably and easily measured or monitored in a space-saving manner, in order to improve or maintain the comfort of the vehicle occupants. An oscillation detection can also be implemented, for example, for moving vehicle parts and also, or alternatively, for rotating vehicle parts, in order to monitor a physical state of such vehicle parts, and to increase safety. In particular, wear to vehicle parts can also be detected early through oscillations, such that tears, breaks, fatigue and overloads in vehicle parts can be avoided.

A method for detecting an oscillation in a vehicle part for a vehicle comprises at least the following steps:
applying an electric excitation signal to at least one electric coil, wherein the at least one electric coil is inductively coupled to at least one position element, wherein the at least one position element is coupled to the vehicle part;
inputting an electric coil signal from the at least one electric coil, wherein the electric coil signal is tapped at the at least one coil in response to the electric excitation signal and affected by the at least one position element; and
determining at least one property of the oscillation of the vehicle part using the input electric coil signal.

The vehicle can be a motor vehicle, in particular a land vehicle, a water vehicle, an aircraft, etc., e.g. a passenger car, a truck or some other utility vehicle. The vehicle part can be incorporated in the vehicle. The vehicle part can move in a translatory and/or rotary manner in relation to the vehicle when it is installed in the vehicle. An oscillation of the vehicle part can cause the at least one position element to oscillate. The at least one position element can be directly or indirectly coupled mechanically to the vehicle part. The electric coil signal represents signal that is tapped at the at least one coil in response to the electric excitation signal and affected by the at least one position element.

According to one embodiment, the steps of the method can be executed during operation of the vehicle. Such an embodiment offers the advantage that a measurement and monitoring of the vehicle part with regard to oscillations can also be carried out while the vehicle is being driven, during a test drive of the vehicle, etc.

In particular, a square-wave signal, a sinusoidal signal, or a signal with some other signal shape can be applied to the at least one electric coil as the electric excitation signal in the application step. In this manner, an appropriate excitation signal can be applied, depending on the oscillation behavior that can be expected, in order to obtain a reliable resolution.

An amplitude, frequency, and/or further variable of an oscillation function can also be determined in the determining step as the at least one property of the oscillation of the vehicle part. Such an embodiment offers the advantage that an oscillation behavior of the vehicle part can be reliably and precisely detected or determined.

Furthermore, a fast Fourier transform of the input electric coil signal can be carried out in the determining step. In this manner, an analysis of the coil signal can be simplified and sped up, in order to reliably detect the oscillation.

In addition, the input electric coil signal can be amplified in the determining step. Such an embodiment offers the advantage that an exact and reliable processing of the coil signal can be obtained, independently of which type of position element is used, or whether a damping of the coil signal by the position element takes place.

According to one embodiment, the method also has a step for generating a detection signal using the at least one property of the oscillation of the vehicle part determined in the determining step. In this case, the detection signal can contain data representing a physical state of the vehicle part, in particular the probability of a tear, break, fatigue, and/or wear occurring in the vehicle part. Such an embodiment offers the advantage that the operating safety of the vehicle can be increased in that it is possible to react in a timely fashion to a malfunction or damage, etc. to the vehicle part.

The approach presented herein also results in a control unit that is configured to execute, actuate, or implement the steps of a variation of one of the methods presented herein in corresponding devices. The fundamental object of the invention can also be quickly and efficiently achieved by this embodiment variation of the invention in the form of a control unit.

For this, the control unit can contain at least one computing unit for processing signals or data, at least one memory for storing signals or data, at least one interface to a sensor or actuator for inputting sensor signals from the sensor or to output control signals to the actuator, and/or at least one communication interface for inputting or outputting data, which are embedded in a communication protocol. The computing unit can be, e.g., a signal processor, a microcontroller, etc., wherein the memory unit can be a flash drive, an EEPROM, or a magnetic memory. The communication interface can be configured for wireless and/or hardwired data input or output, wherein a communication interface that can input or output data in a hardwired manner can input or output these data, e.g. electrically or optically, from or to a corresponding data transfer line.

A control unit in the present case can be understood to be an electrical device that processes sensor signals and outputs control and/or data signal based thereon. The control unit can contain a hardware and/or software interface. With hardware interfaces, these can be part of a so-called system ASIC, for example, which contains the various functions of the control unit. It is also possible for the interfaces to be made of individual, integrated circuits or at least discrete components. Software interfaces can be interfaces in a software module that are available, e.g. on a microcontroller, in addition to other software modules.

A computer program product containing program code is also advantageous, which can be stored on a machine-readable medium such as a semiconductor memory, a hard drive memory, or an optical memory and used for executing the method according to any of the embodiments described above, when the program runs on a computer, a control unit, or a device.

A system for detecting an oscillation of a vehicle part for a vehicle comprises at least the following features:
an embodiment of the control unit specified above; and
at least one detection device, wherein the at least one detection device contains at least one electric coil and at least one position element, wherein the at least one position element can be or is coupled to the vehicle part, wherein the at least one electric coil can be or is inductively coupled to at least one position element, wherein the control unit and the at least one electric coil can be or are coupled to one another for signal transfer.

In the system, an embodiment of the aforementioned control unit can be implemented or used in conjunction with the at least one detection device for detecting the oscillation of the vehicle part.

According to one embodiment, the at least one electric coil can be in the form of a single or multi-layer coil and/or a planar coil. Such an embodiment offers the advantage that, depending on the concrete application of the detection device, a suitable and in particular space saving embodiment of the coil can be selected.

The at least one position element can also be made from an electrically conductive material or an electrically insulating and magnetically permeable material. As a result, depending on the embodiment of the at least one position element, an amplification or damping of the coil signal can be obtained, enabling a reliable and precise detection of the oscillation.

Moreover, the at least one position element can be moved, when it is coupled to the vehicle part, along and/or transverse to a winding axis of the at least one electric coil through an oscillation of the vehicle part. Such an embodiment offers the advantage that, depending on the oscillation of the vehicle part, an appropriate detection and reliable recognition can be obtained.

According to one embodiment, the at least one detection device can contain at least one diaphragm. The at least one position element can be attached to a first side of the at least one diaphragm in this case. Such an embodiment offers the advantage that in applications in which a direct mechanical coupling between the vehicle part and the position element is impractical, an oscillation of the vehicle part can still be reliably and precisely detected.

A vehicle, wherein the vehicle contains at least one vehicle part, comprises at least the following features:
an embodiment of the aforementioned system, wherein the system is configured to detect an oscillation of the at least one vehicle part.

In the vehicle, the system can contain at least one detection device for each vehicle part.

A use of a detection device for detecting an oscillation of a vehicle part for a vehicle is also presented, wherein the detection device contains at least one electric coil and at least one position element, wherein the at least one position element can be or is coupled to the vehicle part, wherein the at least one electric coil is or can be inductively coupled to at least one position element.

### BRIEF DESCRIPTION OF THE DRAWINGS

The invention shall be explained in greater detail based on the attached drawings. Therein:

FIG. 1 shows a schematic illustration of a vehicle that has a system according to an exemplary embodiment of the present invention;

FIG. 2 shows a schematic illustration of a vehicle that has a system according to an exemplary embodiment of the present invention;

FIG. 3 shows a flow chart for a method for detection in accordance with an exemplary embodiment of the present invention;

FIGS. 4a, b show perspective views of a double layer planar coil and a double layer planar coil that has a position/damping element;

FIGS. 4c, d show schematic views of a planar coil that has a hexagonal shaped position/damping element (made of copper or ferrite) and a planar coil that has a rhombic shaped position/damping element; and

FIGS. 5a, b show a schematic illustration of an embodiment of an inductive oscillation sensor and a schematic illustration of the embodiment of an inductive oscillation sensor shown in FIG. 5a, in the installed state, on an oscillating surface.

### DETAILED DESCRIPTION

In the following description of preferred exemplary embodiments of the present invention, the same or similar reference symbols shall be used for the elements shown in the various figures that have the similar functions, wherein there shall be no repetition of the descriptions of these elements.

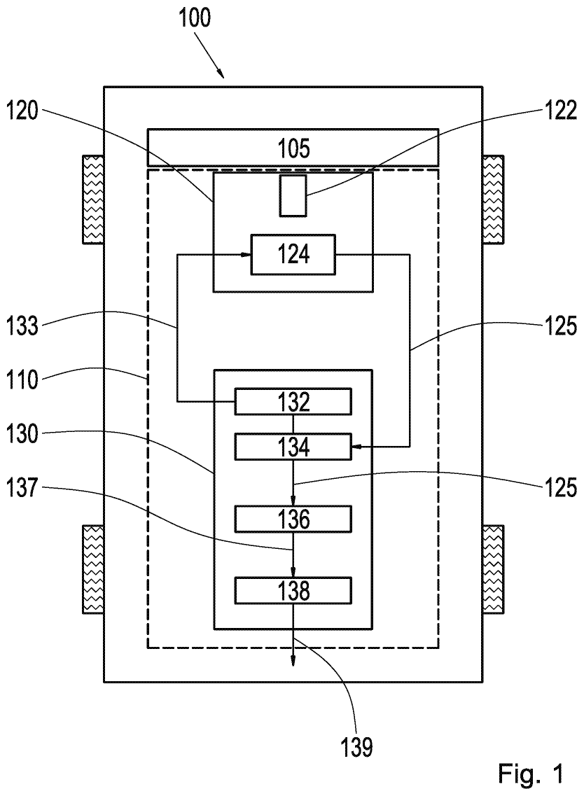

FIG. 1 shows a schematic illustration of a vehicle 100 that has a system 110 according to an exemplary embodiment of the present invention. The vehicle 100 is a motor vehicle, in particular a passenger car, truck, or some other utility vehicle. The vehicle 100 contains at least one vehicle part 105 and the system 110. According to the exemplary embodiment of the present invention shown in FIG. 1, the vehicle 100 contains only one vehicle part 105, by way of example, or only one vehicle part 105 is indicated in the vehicle 100, by way of example. The vehicle part 105 can be subject to oscillation when the vehicle 100 is operated, for example. The vehicle part 105 can also be located in the vehicle 100 such that it can be rotated or displaced in relation to the vehicle 100. The system 110 is configured to detect an oscillation of the vehicle part 105.

The system 110 comprises at least one detection device 120 and one control unit 130. According to the exemplary embodiment of the present invention shown in FIG. 1, the system 110 contains only one detection device 120, and the control unit 130, by way of example. The control unit 130 and the detection device 120 are connected to one another for signal transfer.

The detection device 120 contains at least one position element 122 and at least one electric coil 124. According to the exemplary embodiment of the present invention presented herein, the detection device 120 contains only one position element 122, by way of example, and only one electric coil 124, by way of example. The position element 122 and the electric coil 124 are adjacent to one another. The position element 122 and the electric coil are inductively coupled to one another therein.

The position element 122 is coupled to the vehicle part 105. More precisely, the position element 122 is mechanically attached directly or indirectly to the vehicle part 105, or coupled to the vehicle part 105 such that it reacts to oscillations. According to one exemplary embodiment, the position element 122 is made of an electrically conductive material. According to another exemplary embodiment, the position element 122 is made of an electrically insulating and magnetically permeable material. When it is coupled to the vehicle part 105, the position element 122 can be moved along and/or transverse to a winding axis of the electric coil 124 by an oscillation of the vehicle part 105, according to an exemplary embodiment. The electric coil 124 is connected to the control unit 130 in the system 110 for signal transfer. The electric coil 124 is in the form of a single- or multi-layer coil. Additionally or alternatively, the electric coil 124 is a planar coil.

The control unit 130 is configured to control detection of the oscillation of the vehicle part 105 and/or carry out a detection using the detection device 120. For this, the control unit 130 contains an application element 132, an input element 134 and a determination element 136. The application element 132 is configured to apply an electric excitation signal 133 to the electric signal 124. The excitation signal 132 is a square-wave signal, a sinusoidal signal, or a signal with some other signal shape. The input element 134 is configured to input an electric coil signal 125 from the electric coil 124. The electric coil signal 125 is a signal that is tapped at the electric coil 124 in response to the electric excitation signal 133, and affected by the at least one position element 122, or its effect on the excitation signal 133. The input element 134 is also configured to forward the electric coil signal 125 to the determination element 136.

The determination element 136 is configured to determine at least one property of oscillation of the vehicle part 105 based on the electric signal 125. By way of example, the determination element 136 is configured to determine an amplitude, frequency, and/or further variable of an oscillation function in the form of at least one property of the oscillation of the vehicle part 105. The determination element 136 according to an exemplary embodiment is configured to execute a fast Fourier transform on the input electric coil signal 125, and/or to amplify the electric coil signal 125. The determination element 136 is also configured to provide property data 137 that represents a determined property of the oscillation.

According to the exemplary embodiment of the present invention illustrated in FIG. 1, the control unit 130 also contains a generating element 138. The generating element 138 is configured to generate a detection signal 139 based on the property data 137. The detection signal 139 represent data regarding the physical state of the vehicle part 105. The data regarding the physical state may relate, for example, to the probability of a tear, break, fatigue, and/or wear in the vehicle part 105.

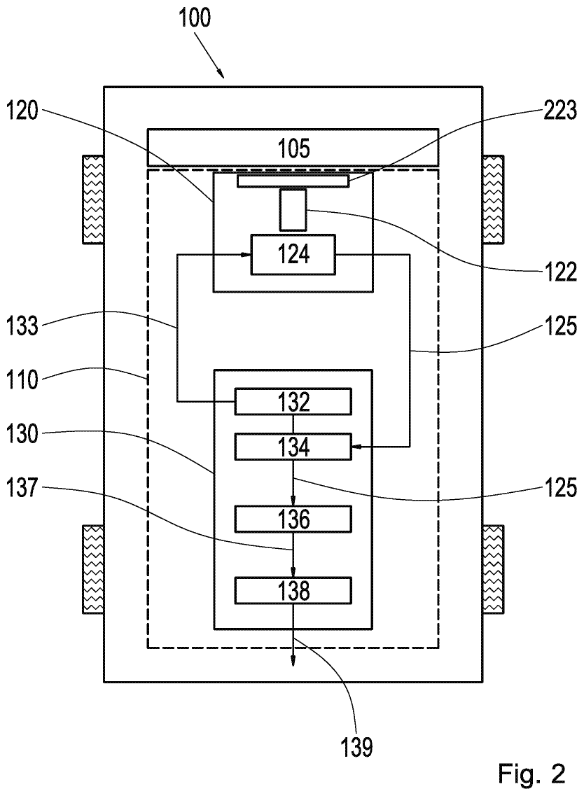

FIG. 2 shows a schematic illustration of a vehicle 100 that has a system 110 according to an exemplary embodiment of the present invention. The system 110 corresponds to the system shown in FIG. 1, with the exception that the detection device 120 contains a diaphragm 223, to which the position element 122 is attached. The position element 122 is attached to a first side of the diaphragm 223. A second side of the diaphragm 223, facing away from the first side, is placed on the vehicle part 105, or faces the vehicle part 105.

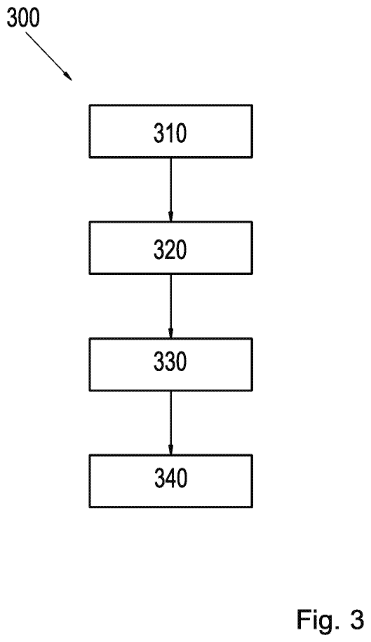

FIG. 3 shows a flow chart for a method 300 for detecting according to an exemplary embodiment of the invention. The method 300 can be executed to detect an oscillation of a vehicle part for a vehicle. The method 300 for detecting can be executed in conjunction with the system and/or by means of the control unit and using the detection device shown in FIG. 1 and FIG. 2, or a similar system, a similar control unit, and the detection device.

In an application step 310, an electric excitation signal is applied to the at least one electric coil of the detection device in the method 300. Subsequently, in an input step 320, an electric coil signal from the at least one electric coil is input. The electric coil signal represent a signal that is tapped at the at least one coil in response to the electric excitation signal applied in the application step 310, and affected by the at least one position element. Subsequently, in a determining step 330, at least one property of the oscillation of the vehicle part is determined using the electric coil signal that has been input in the input step 320.

According to an exemplary embodiment, the method 300 also has a step 340 for generating a detection signal using the at least one property of the oscillation of the vehicle part determined in the determining step 330. The detection signal represents a datum regarding a physical state of the vehicle part, in particular a probability of a tear, break, fatigue and/or a wear in the vehicle part.

According to another exemplary embodiment, at least the application step 310, the input step 320, and the determining step 330 are carried out during operation or testing the vehicle.

Exemplary embodiments of the present invention shall be described and/or briefly explained differently, in reference to FIGS. 1 to 3, in a summarizing manner.

An inductive oscillation detection can be carried out by the system 110, or by executing the method 300 using at least one single-layer or multi-layer (double layer) planar coil 125 that has a conductive metal piece, e.g. made of copper, aluminum, or brass, that slides horizontally or moves vertically over the at least one planar coil 124 that serves as a position element 122, wherein the electric coil 124, or planar induction coil, generates a variable coil signal 125, the value and frequency of which changes with an oscillation frequency (both vertical as well as horizontal), or movement path (vertical and horizontal) of the conductive metal piece, or position element 122, under the influence of eddy current damping effects.

Alternatively, an electrically non-conductive, or insulating, but magnetically permeable, actuator element, or position element 122, can be used instead of the conductive position element made of copper, aluminum or brass. In order to measure the oscillation, a robust but thin diaphragm 223 made of plastic, polymer, or some other suitable material, to which the actuator element, or position element 122, is securely attached, can also be used, wherein the second side of the diaphragm 223 is located on the vehicle part 105 or an oscillating surface. The diaphragm 223 moves vertically up and down with the oscillating surface at an oscillating frequency, thus also causing the position element 122 to move vertically up and down above/below the electric coil 124 with the same frequency. The vertical upward and downward movements of the position element 122 generate a corresponding coil signal 125, in particular an electric voltage, which can be amplified with appropriate electronic circuits, and the amplitude and frequency of the oscillation of the conductive position element 122, or the actuating element, can be determined from the coil signal 125, e.g. by means of a fast Fourier transform (FFT). The electric coil 124 can be excited with a square-wave, rectangular, or sinusoidal signal serving as the excitation signal 133.

Alternatively to an electrically conductive material, such as copper, aluminum, brass, etc., a highly permeable ferrite material (electrically non-conductive, or insulating) can be used for the position element 122. In the latter case, the coil signal 125 is amplified by the highly permeable ferrite material instead of damped.

A slight modification of the electric circuits and the physical placements of the thin, robust diaphragm 223 and the position element (actuator element) 122, and the at least one coil 124, or planar coil, can be carried out in order to obtain an inductive sensor for pressure, force/compression pressure, sound (noise), and displacement (in all three spatial directions, x, y, z).

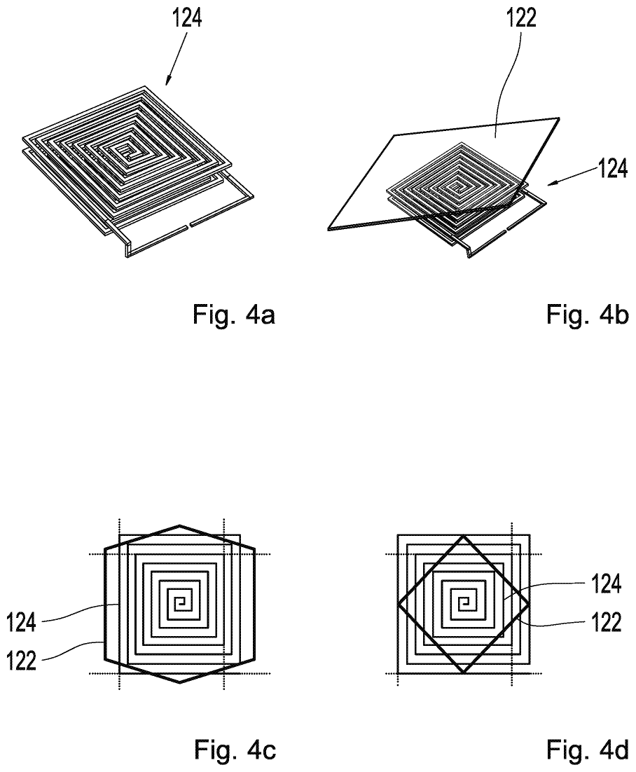

FIG. 4a shows a perspective view of a double layer planar coil, which can serve as the coil 124 in a system for oscillation detection. The planar coil can be printed onto a printed circuit board, for example.

FIG. 4b shows a double layer planar coil 124 that has a position element 122/damping element, wherein the position element 122 is in the form of a rhombus-shaped copper element. The rhombus or diamond shaped position element has an effect on the inductivity of the coil 124, depending on the distance to the coil 124.

FIG. 4c shows a schematic top view of a planar coil that has a hexagonal position element/damping element 122, wherein only the shape of the position element 122 is indicated. The position element 122 can be made of copper, and in this case serves to further dampen the inductivity of the coil 124 as the position element 122 approaches the coil 124. The position element can also be made of a ferrite. In this case, the inductivity of the coil 124 increases as the distance between the coil 124 and the position element 122 decreases.

FIG. 4d shows a planar coil 124 with the shaped form of a diamond-shaped position element/damping element 122. The shape of the position element 122 plays a role in the damping properties of the position element 122 with respect to the inductivity of the coil 124.

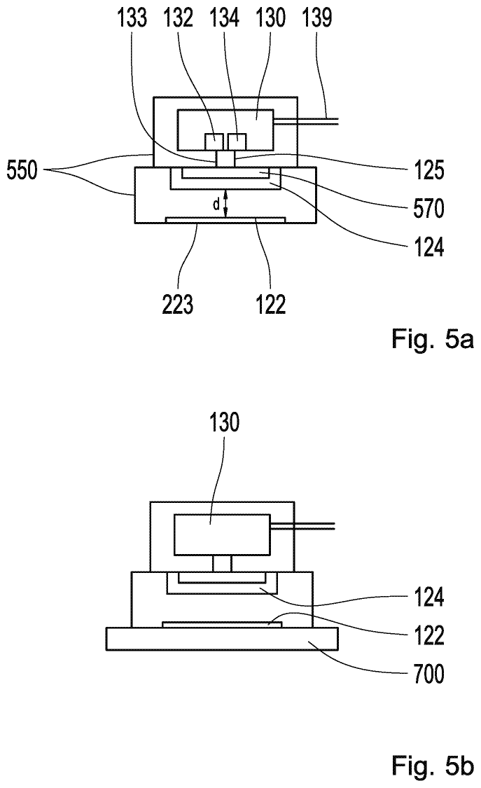

FIG. 5a shows a schematic illustration of an embodiment of an inductive oscillation sensor, and FIG. 5b shows a schematic illustration of the embodiment of an inductive oscillation sensor shown in FIG. 5a, in the installed state on an oscillating surface 700. The inductive oscillation sensor can be understood to be a system 110 for oscillation detection. The sensor 110 comprises a housing 550 made of a plastic. A lower surface of the housing 550 is closed off by a diaphragm 223. A position element 122 is located on the diaphragm 223 in the interior of the housing 550. The diaphragm 223 and the position element 122 are configured to oscillate synchronously with the oscillating surface 700 of a monitored vehicle part. An electric coil 124 is located opposite the position element 122 on a circuit board 570. The coil 124 and the position element 122 are spatially separated from one another, at a spacing d. The spacing d can be between 0.15 and 0.45 mm, for example. The change in spacing as a result of the oscillations alters the inductivity of the coil 124. A monitoring of the inductivity can thus serve as a means for monitoring the oscillation of the vehicle part.

The sensor 110 also comprises a control unit 130 that has an application element 132 and an input element 134. The application element 132 sends an excitation signal 133 to the coil 124. The input element 134 is used to input a coil signal 125 from the coil 124. The control unit 130 outputs a detection signal 139.

If an exemplary embodiment comprise an “and/or” conjunction between a first feature and a second feature, this can be read to mean that the exemplary embodiment according to one embodiment contains both the first feature and the second feature, and contains either just the first feature or just the second feature according to another embodiment.

### REFERENCE SYMBOLS

100 vehicle
105 vehicle part
110 detection system
120 detection device
122 position element
124 electric coil
125 coil signal
130 control unit
132 application element
133 excitation signal
134 input element
136 determination element
137 property data
138 generation element
139 detection signal
223 diaphragm
300 detection method
310 application step
320 input step
330 determining step
340 generating step
550 housing
570 printed circuit board
700 oscillating surface

1. A method for detecting an oscillation of a vehicle part for a vehicle, the method comprising:
applying, by a control unit, an electric excitation signal to at least one electric coil inductively coupled to at least one position element, wherein the at least one position element is coupled to the vehicle part;
inputting, to the control unit, an electric coil signal from the at least one electric coil, wherein the electric coil signal is created at the at least one coil in response to the electric excitation signal as affected by the at least one position element; and
determining, by the control unit, at least one property of the oscillation of the vehicle part based on the input electric coil signal.

2. The method according to claim 1, wherein the method is carried out during operation of the vehicle.

3. The method according to claim 1, wherein the electric excitation signal comprises at least one of a square-form signal, a sinusoidal signal, or a signal with another signal shape.

4. The method according to claim 1, further comprises determining at least one of an amplitude, a frequency, or another variable of an oscillation function as the at least one property of the oscillation of the vehicle part.

5. The method according to claim 1, further comprising determining a fast Fourier transform of the input electric coil signal.

6. The method according to claim 1, further comprising amplifying the input electric coil signal.

7. The method according to claim 1, further comprising generating a detection signal based on the at least one property of the oscillation of the vehicle part, wherein the detection signal represents a datum regarding a physical state of the vehicle part.

8. A control unit comprising:
an output configured to apply an electric excitation signal to at least one electric coil inductively coupled to at least one position element, wherein the at least one position element is coupled to a vehicle part;
an input configured to receive an electric coil signal from the at least one electric coil, wherein the electric coil signal is created at the at least one coil in response to the electric excitation signal as affected by the at least one position element; and
a processing device configured to determine at least one property of an oscillation of the vehicle part based on the received electric coil signal.

9. A system for detecting the oscillation of the vehicle part for a vehicle comprising:
the control unit according to claim 8; and
at least one detection device comprising:
the at least one electric coil; and
the at least one position element coupled to the vehicle part, wherein the at least one electric coil is inductively coupled to the at least one position element;
wherein the control unit and the at least one electric coil are coupled to one another for signal transfer.

10. The system according to claim 9, wherein the at least one electric coil comprises at least one of a single-layer coil, a multi-layer coil, or a planar coil.

11. The system according to claim 9, wherein the least one position element comprises at least one of an electrically conductive material or an electrically insulating and magnetically permeable material.

12. The system according to claim 9, wherein the at least one position element can move when it is coupled to the vehicle part relative to the at least one electric coil through an oscillation of the vehicle part.

13. The system according to claim 9, where the at least one detection device comprises at least one diaphragm, wherein the at least one position element is attached to a first side of the at least one diaphragm, and wherein a second side of the diaphragm is placed on the vehicle part.

14. A vehicle comprising the vehicle part and the system according to claim 9.

15. A method for detecting an oscillation of a vehicle part for a vehicle, the method comprising:
coupling at least one position element of a detection device to the vehicle part;
inductively coupling at least one electric coil of the detection device to the at least one position element;
receiving, by a control unit, an electric coil signal from the at least one electric coil created, at least in part, by an influence of the at least one position element on the at least one electric coil; and
determine, by the control unit, at least one property of the oscillation of the vehicle part based on the received electric coil signal.

16. The system according to claim 12, wherein the at least one position element can move when it is coupled to the vehicle part at least one of along or transverse to a winding axis of the at least one electric coil through the oscillation of the vehicle part.

17. The control unit according to claim 8, wherein the electric excitation signal comprises at least one of a square-form signal, a sinusoidal signal, or a signal with another signal shape.

18. The control unit according to claim 8, wherein the processing device is further configured to determine at least one of an amplitude, a frequency, or another variable of an oscillation function as the at least one property of the oscillation of the vehicle part.

19. The control unit according to claim 8, wherein the processing device is further configured to determine a fast Fourier transform of the received electric coil signal.

20. The method according to claim 7, wherein the detection signal represents a datum regarding a probability of at least one of a tear, a break, fatigue, or wear in the vehicle part.
